(19) United States
(12) Patent Application Publication
(10) Pub. No.: US 2025/0302227 A1
(43) Pub. Date: Oct. 2, 2025

(54) BEVERAGE MACHINE WITH FLOW ARRANGEMENT

(71) Applicant: Keurig Green Mountain, Inc., Burlington, MA (US)

(72) Inventors: Jason Scott Sabel, Northborough, MA (US); Wai Kean Chan, Singapore (SG); Chin Khiong Lim, Singapore (SG)

(73) Assignee: Keurig Green Mountain, Inc., Burlington, MA (US)

(21) Appl. No.: 18/875,842

(22) PCT Filed: Jun. 29, 2023
(86) PCT No.: PCT/US2023/026558

§ 371 Date: Dec. 17, 2024

Related U.S. Application Data
(60) Provisional application No. 63/359,287, filed on Jul. 8, 2022.

(51) Int. Cl. A47J 31/10

(52) U.S. Cl. CPC A47J 31/10

(57) ABSTRACT

A beverage machine may have first and second brew chambers that are configured to brew different types of drinks compared to one another. The beverage machine may have a first heater and a second heater that are separate and distinct from one another. The first heater may be a dedicated heater for the first brew chamber, and the second heater may be a dedicated heater for the second brew chamber. The first and second heaters may be different types of heaters. The beverage machine may use a common liquid supply that splits into two flow pathways by a valve: one that leads to the first heater and first brew chamber and a second that leads to the second heater and second brew chamber.

### CROSS-REFERENCE TO RELATED APPLICATION

This application claims the benefit of U.S. Provisional Application No. 63/359,287, filed Jul. 8, 2022, which is hereby incorporated by reference in its entirety.

### BACKGROUND

### 1. Field

Disclosed embodiments are related to beverage machines and methods of forming a beverage.

### 2. Related Art

Beverage machines that use a liquid, such as water, to form a beverage are well known. For example, a beverage machine may introduce liquid to a beverage material to form a beverage. The liquid provided to the beverage material may be heated in a tank prior to delivery to the beverage material.

### SUMMARY

According to one aspect, a beverage machine is provided. The beverage machine may comprise a liquid supply configured to provide a liquid for forming a beverage. A first brew chamber of the beverage machine may be configured to hold a first beverage material and introduce liquid from the liquid supply to the first beverage material to form a first beverage of a first type of beverage. The first brew chamber may be configured to introduce liquid to the first beverage material at a pressure of less than 1 bar. A second brew chamber of the beverage machine may be configured to hold a second beverage material and introduce liquid from the liquid supply to the second beverage material to form a second beverage of a second type of beverage, the second type of beverage being different from the first type of beverage. The second brew chamber may be incapable of brewing the first type of beverage. The second brew chamber may be configured to introduce liquid to the second beverage material at a pressure of less than 1 bar. The beverage machine may include a pump configured to pump the liquid from the liquid supply to the first brew chamber and to the second brew chamber. The beverage machine may include a valve downstream of the pump. The valve may be configured to selectively control flow of liquid from the pump toward the first brew chamber and toward the second brew chamber. The beverage machine may include a controller in communication with the valve. The controller may be configured to actuate the valve to selectively control flow of liquid from the pump toward the first brew chamber and toward the second brew chamber. A first heater of the beverage machine may be configured to heat liquid directed to the first brew chamber. A second heater of the beverage machine may be configured to heat liquid directed to the second brew chamber. The first heater and the second heater may be different types of heaters and may be downstream of the valve.

According to another aspect, a beverage machine is provided. The beverage machine may include a liquid supply configured to provide a liquid for forming a beverage. A first brew chamber of the beverage machine may include a cartridge holder configured to receive a beverage cartridge. The first brew chamber may be configured to introduce liquid from the liquid supply into the beverage cartridge to form a first beverage. A second brew chamber of the beverage machine may be configured to hold a beverage material and configured to introduce liquid from the liquid supply to the beverage material to form a second beverage. The second brew chamber may be configured to introduce liquid to the second beverage material at a pressure of less than 1 bar. The beverage machine may include a pump configured to pump the liquid from the liquid supply to the first brew chamber and to the second brew chamber. The beverage machine may further include a valve downstream of the pump. The valve may be configured to selectively control flow of liquid from the pump toward the first brew chamber and toward the second brew chamber. The beverage machine may additionally include a controller in communication with the valve. The controller may be configured to actuate the valve to selectively control flow of liquid from the pump toward the first brew chamber and toward the second brew chamber. A first heater of the beverage machine may be configured to heat liquid directed to the first brew chamber. A second heater of the beverage machine may be configured to heat liquid directed to the second brew chamber. The first heater and the second heater may be downstream of the valve.

According to yet another aspect, a method of forming a beverage is provided. The method may include providing a liquid supply, a pump, and a valve. The method may include providing a first brew chamber that may be configured to receive a beverage cartridge and configured to introduce liquid from the liquid supply into the beverage cartridge to form a first beverage. The method may include providing a second brew chamber that may be configured to hold a beverage material and may be configured to introduce liquid from the liquid supply to the beverage material to form a second beverage. The method may include pumping, with the pump, liquid from the liquid supply through the valve. The method may include directing the liquid through the valve toward either the first brew chamber or the second brew chamber, and heating the liquid after the liquid has passed through the valve. Heating the liquid may include using a first heater to heat liquid directed toward the first brew chamber, or using a second heater to heat liquid directed toward the second brew chamber.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front perspective view of a beverage machine according to some embodiments;

FIG. 2 is a schematic diagram illustrating a flow arrangement of a beverage machine according to some embodiments; and

FIG. 3 illustrates a flow arrangement of a beverage machine according to one illustrative embodiment.

### DETAILED DESCRIPTION

The inventors have appreciated that there is a benefit to providing a single beverage machine that is capable of brewing different types of beverages. In some embodiments described herein, a single beverage machine has two brew chambers that brew a different type of beverage. The inventors have recognized that such a beverage machine may allow a user to brew a larger variety of beverages with a single machine.

The inventors have also recognized that existing beverage machines with two or more beverage dispensing stations can have complex and/or inefficient flow arrangements. For example, some existing machines use distinct parallel flow paths, one for each beverage dispensing station. Such machines may have multiples of every component, e.g. two or more liquid supply tanks and/or two or more pumps, etc. Some machines may have some shared components, but may still have multiple pumps.

According to one aspect, in some embodiments, a beverage machine having multiple brew chambers may use only a single pump to direct the flow to each of the brew chambers. In some embodiments, the beverage machine may also pump liquid from a single common liquid supply. Configurations disclosed herein may provide increased efficiency and/or a smaller form factor.

In some embodiments, a beverage machine may use a single pump as the sole fluid driving source that moves liquid from the liquid supply to the first brew chamber and to the second brew chamber. As compared to, e.g. an espresso brewer which may rely on steam pressure to drive liquid to a brew chamber, the beverage machine may require only the single pump to drive liquid to the brew chambers without needing steam pressure.

In some embodiments, the pressure of the liquid supplied to the brew chambers may remain relatively low, e.g. less than 1 bar. As such, in some embodiments, the brew chambers may be used to produce non-espresso beverages. For example, in some embodiments, a first brew chamber may be a single serve cartridge brewing chamber, and a second brew chamber may be a carafe drip coffee brewer.

In other embodiments, however, at least one of the brew chambers may be configured to brew espresso and other beverages formed from espresso (e.g. Americano, latte, cappuccino, macchiato, cortado, etc.)

In some embodiments, a beverage machine may include a valve that selectively controls flow of liquid from a liquid supply toward the first brew chamber and toward the second brew chamber. The inventors have recognized that, in some embodiments, it may be beneficial to position the valve upstream of any heater such that only unheated water passes through the valve. The inventors have found that, in some arrangements, running heated water through a valve may cause build-up of scale in the valve. The inventors have appreciated that such scale build-up may interfere with the operation of the valve and may require more frequent cleaning and/or maintenance of a beverage machine.

According to one aspect, in some embodiments, a beverage machine may include a valve to direct flow toward a first brew chamber and a second brew chamber, where the valve is positioned upstream of any heater. In some embodiments, each brew chamber may have its own associated heater downstream of the valve. For example, each heater may be disposed between the valve and a chamber associated with the heater. Configurations disclosed herein may provide increased reliability and reduced maintenance requirements in comparison to machines that include one or more heaters upstream of a valve.

In some embodiments, the beverage machine may be configured to permit only one of the brew chambers to brew a beverage at a time. In other words, the brew chambers cannot simultaneously brew a beverage. In some embodiments, the valve may be configured to control flow of liquid from the liquid supply to only one of the first and second brew chambers at a time.

Described herein are embodiments of beverage machines that may include multiple brew chambers, for example, a first brew chamber and a second brew chamber. In some embodiments, the first and second brew chambers may brew different types of beverages. Different types of beverages include beverages of different volumes (e.g. single serve vs. carafe), different temperatures (e.g. hot coffee vs. cold brew), different pressures (e.g. gravitational as with drip brewing vs. pressurized as with espresso), different brewing styles (e.g. decoction, infusion, gravitational feed, or pressurized percolation), or any other suitable category.

In some embodiments, the second brew chamber may be incapable of brewing one or more of the beverages brewed by the first brew chamber. For example, in some embodiments, the first brew chamber may be a single serve cartridge brewer and the second brew chamber may be a carafe drip coffee brewer. The carafe drip coffee brewer may be unable to form a single service cartridge type of beverage. In some embodiments, the single serve cartridge brewer may have one or more needles to pierce the cartridge in order to introduce liquid into the cartridge to form a beverage from the cartridge. The carafe drip coffee brewer may have no such needles and may be thus unable to introduce liquid into the cartridge to form a beverage from the cartridge.

According to one aspect, the inventors have appreciated that, with a designated heater for each brew chamber, the heaters need not be identical. Instead, the heaters may be of different types to be more finely tuned to the type of beverage(s) formed by its associated brew chamber. The inventors have recognized that having heaters of different types may help to create a more efficient beverage machine.

In some embodiments, the first and second brew chambers may have different volume capabilities. In other words, a maximum beverage volume that may be brewed by the first brew chamber may be different from a maximum beverage volume that may be brewed by the second brew chamber.

In some embodiments, a first heater may heat liquid provided to the first brew chamber, and a second heater may heat liquid provided to the second brew chamber. In some embodiments, a first brew chamber may brew a smaller maximum beverage volume than that of a second brew chamber. The first and second heaters may, in turn, have different ratings to match the output volumes of their associated brew chambers. As such, in some embodiments, as compared to the first heater, the second heater may have a heater rating that enables the second heater to heat a volume of water to an elevated temperature in less time than required by the first heater to heat the same volume of water to the same elevated temperature.

In some embodiments, the first and second heaters may have different power consumption requirements. In some embodiments, the first and second heaters may have different maximum flow rates.

In some embodiments, at least one of the heaters may provide a second function other than heating liquid on its way to a brew chamber. For example, in some embodiments, a heater may both heat liquid and also heat a warming plate.

Described herein are embodiments of a beverage machine having multiple brew chambers. In some embodiments, a common liquid supply, a single pump, a valve, a first brew chamber, and a second brew chamber may be provided. In certain embodiments, the first brew chamber may be configured to receive a beverage cartridge and may be configured to introduce liquid from the liquid supply into the beverage cartridge to form a first beverage. In some such embodiments, a beverage cartridge may be received in the first brew chamber, and a beverage may be formed from the beverage cartridge. In certain embodiments, the second brew chamber may be configured to hold a beverage material and may be configured to introduce liquid from the liquid supply to the beverage material to form a second beverage. In some such embodiments, a beverage may be dispensed from the second brew chamber into a carafe. In some embodiments, the second brew chamber may be a carafe drip coffee brewer.

Liquid may be pumped from the liquid supply through the valve. In some embodiments, the pump may serve as the sole fluid driving source toward the first brew chamber and the second brew chamber.

The liquid may be directed through the valve toward either the first brew chamber or the second brew chamber. In some embodiments, the liquid may be directed through the valve based upon a user selection. In some such embodiments, the user selection may be made by a user interacting a user interface of a beverage machine.

Liquid directed toward the first brew chamber may be heated using a first heater. Liquid directed toward the second brew chamber may be heated using a second heater. Both first and second heaters may be positioned downstream of the valve. In some embodiments, the first and second heaters are heaters of different types. In some embodiments, the first and second heaters have different ratings to match the output volumes of their associated brew chambers. In some embodiments, as compared to the first heater, the second heater may have a heater rating that enables the second heater to heat a volume of water to an elevated temperature in less time than required by the first heater to heat the same volume of water to the same elevated temperature.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

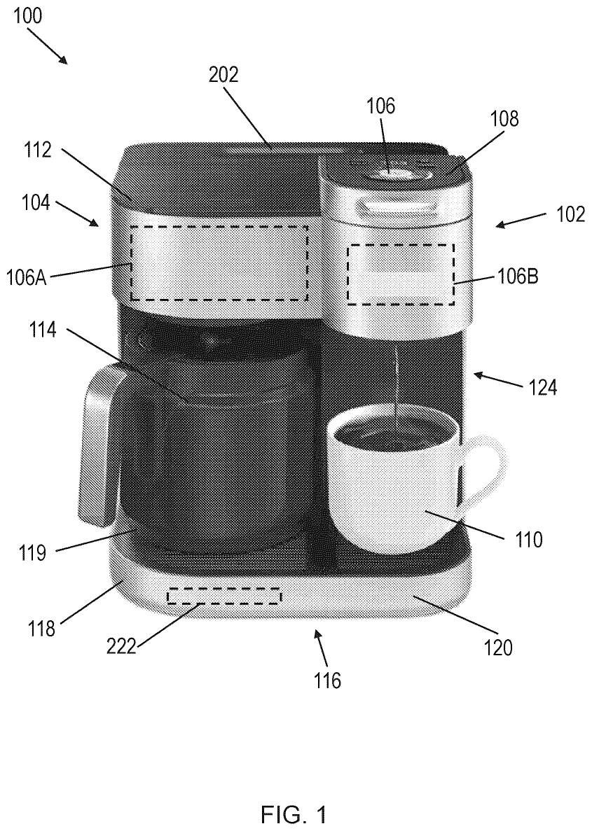

FIG. 1 shows one embodiment of a beverage machine according to the present disclosure. The beverage machine 100 may include a housing 124 to enclose one or more components of the beverage machine 100. The beverage machine 100 may include a first brew chamber 102, a second brew chamber 104, and a liquid supply 202 (e.g. a water tank). In some embodiments, each of the first and second brew chambers may be configured to hold a beverage material and may be configured to introduce liquid from the liquid supply to the beverage material to form a beverage.

In some embodiments, the liquid supply may be a removable water tank. It should be appreciated, however, that in some embodiments, the beverage machine may be plumbed to have a direct connection to a water line. As such, in some embodiments, the liquid supply may be a water line rather than a tank. Each of the first brew chamber 102 and the second brew chamber 104 may be configured to form a beverage using a liquid provided by the liquid supply 202.

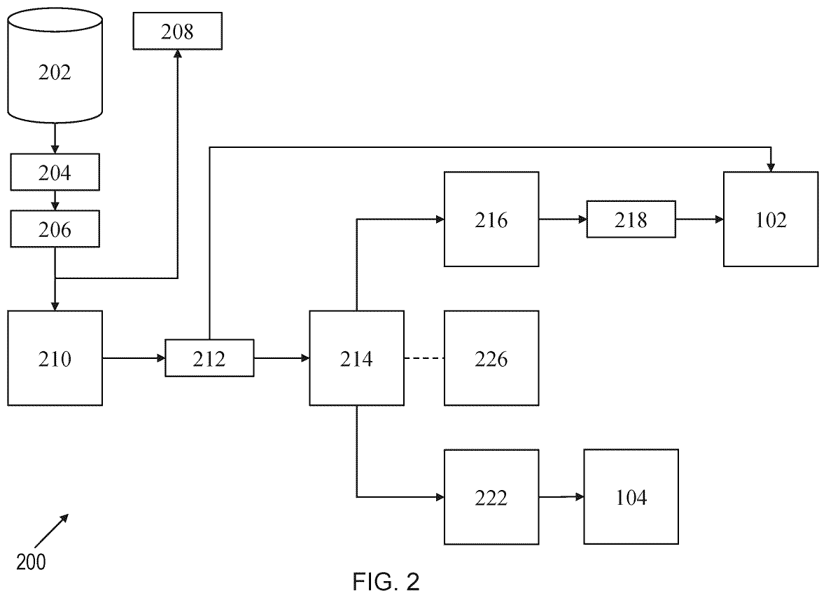

An illustrative embodiment of a flow arrangement 200 of the beverage machine is shown in the schematic diagram of FIG. 2. In some embodiments, the liquid supply 202 may serve as a common supply for both the first brew chamber 102 and the second brew chamber 104. In some embodiments, a single pump 210 may drive liquid from the liquid supply 202 through a valve 214. The valve 214 may split the flow path, such that each brew chamber 102, 104 may be associated with a separate flow path. Each flow path may include a designated heater. A first heater 216 may heat liquid that has been directed to the first brew chamber 102, and a second heater 222 may heat liquid that has been directed to the second brew chamber 104. Both heaters 216, 222 may be positioned downstream of the valve 214. In some embodiments, the pump 210 may serve as the sole fluid driving source that moves liquid from the liquid supply 202 to the first brew chamber 102 and to the second brew chamber 104.

In some embodiments, the valve 214 may be configured to selectively control flow of liquid from the pump 210 to the first brew chamber 102 and to the second brew chamber 104. In some embodiments, the valve 214 may be configured to control flow of liquid from the liquid supply to only one of the first and second brew chambers at a time.

In some embodiments, the valve 214 may have at least 3 operational configurations: (1) allow flow toward the first brew chamber only, (2) allow flow toward the second brew chamber only, and (3) allow flow toward both the first and second brew chambers. The valve 214 may also have a fourth operational configuration in which no flow is permitted through the valve. In some embodiments, the valve 214 may permit flow toward only one of the brew chambers at a time, as opposed to permitting flow toward both brew chambers simultaneously. In some such embodiments, the valve 214 may also have a third operational configuration in which no flow is permitted through the valve.

In some embodiments, the valve 214 may be a three-way valve. In some such embodiments, a three-way valve may have an inlet, a first outlet, and a second outlet. In such embodiments, the first outlet may be fluidly coupled to the first brew chamber 102 and the second outlet may be fluidly coupled to the second brew chamber 104. In some such embodiments, the three-way valve may be configured to selectively direct flow from the inlet to either the first outlet or the second outlet, but not simultaneously. Such configurations may allow the valve 214 to selectively direct flow toward one of the first brew chamber 102 and the second brew chamber 104, but not simultaneously. However, in other embodiments, a three-way valve may permit simultaneous flow to both the first outlet and the second outlet, and thus may permit simultaneously flow toward both the first brew chamber and the second brew chamber.

The valve 214 may be any appropriate type of valve, including a ball valve, a solenoid valve, or any other suitable valve.

In some embodiments, the valve 214 may be in electrical and/or mechanical communication with a controller 226 of the beverage machine. The controller 226 may be in electrical and/or mechanical communication with a user interface, or the controller 226 may be integrated into the user interface. The controller 226 may be configured to actuate the valve 214 to selectively direct the liquid from the pump 210 to one of the first brew chamber 102 and the second brew chamber 104. In some embodiments, the controller 226 may be configured to actuate the valve 214 based on information provided by a user. For example, in some embodiments, the controller 226 may be configured to actuate the valve 214 in response to a user selection made by a user interacting with the user interface. In other embodiments, the controller 226 may be configured to actuate the valve 214 based on information received from an electromechanical component of the beverage machine (e.g., based on an operation or movement of a chamber lid, as described above).

The first heater and second heaters 216, 222 may be any appropriate type of heater, boiler, or heat exchanger. For example, in some embodiments, the first heater and/or second heater may be a flow through heater, including a flat flow through heater, a spiral flow through heater, a U-shaped flow through heater, or any other type of heater. In some embodiments, the first heater and/or second heater may be a heating element that heats a hot water tank. The first heater and/or second heater may be in thermal communication with the hot water tank, e.g. inside the hot water tank in direct contact with the water inside the tank, or in a non-water contact arrangement in which the heater is provided outside the tank or embedded within the tank wall. In some embodiments, the first and second heaters are the same type of heater. In some embodiments, the first and second heaters are different types of heaters.

In one illustrative embodiment, the first brew chamber 102 may form a smaller maximum beverage volume than that of the second brew chamber 104. As such, the heater requirements needed to support the first brew chamber may be different than that of the second brew chamber. In some embodiments, the first heater has a different rating than the second heater. In some embodiments, as compared to the first heater, the second heater may have a heater rating that enables the second heater to heat a volume of water to an elevated temperature in less time than required by the first heater to heat the same volume of water to the same elevated temperature. In some embodiments, the first and second heaters have different power consumption requirements. In some embodiments, the first and second heaters may have different maximum flow rates.

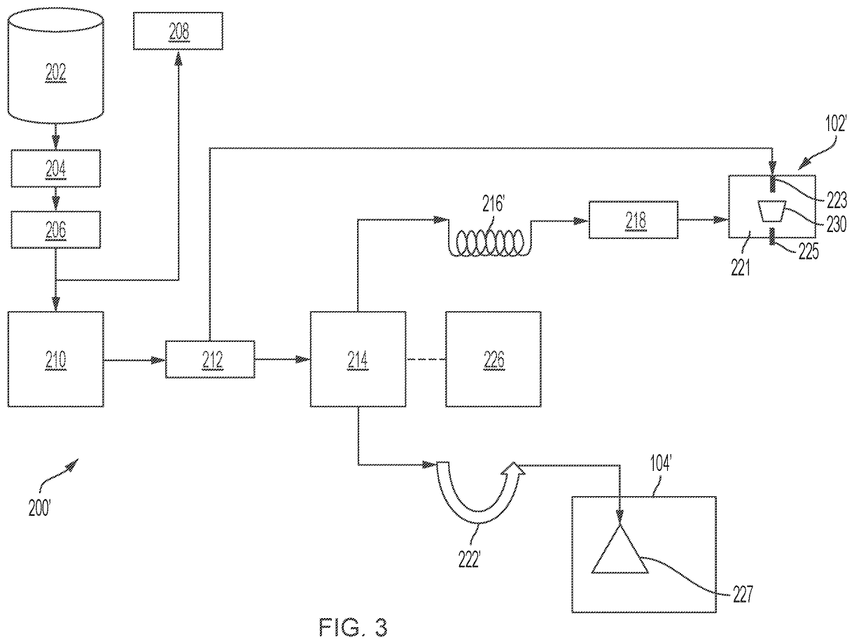

In one illustrative embodiment, the first and second heaters 216, 222 are both flow through heaters, but of different types. In one illustrative embodiment shown in FIG. 3, the first heater 216′ is a spiral flow through heater, while the second heater 222′ is a U-shaped flow through heater.

In some embodiments, the beverage machine may include a supply liquid temperature sensor 204 to detect a temperature of the liquid from the liquid supply 202. The supply liquid temperature sensor 204 may be any temperature sensor or detector capable of detecting or responding to a temperature of the liquid. For example, the supply temperature sensor may be a thermocouple, a thermistor, a thermometer, or other temperature-sensitive device.

In some embodiments, a temperature sensor may be provided between a heater and a brew chamber in some embodiments. In the embodiment shown in FIG. 2, a first temperature sensor 218 may be provided between the first heater 216 and the first brew chamber 102. The first temperature sensor 218 may be any temperature sensor or detector capable of detecting or responding to a temperature of the liquid. For example, the first temperature sensor 218 may be a thermocouple, a thermistor, a thermometer, or other temperature-sensitive device such as a thermal cutoff switch (TCO).

The first temperature sensor 218 may be configured to detect or respond to a temperature of the liquid exiting the first heater 216. In some embodiments, the first temperature sensor 218 may be a TCO configured to break a power circuit of the first heater 216 if a particular temperature is reached, thereby turning off the first heater 216. In other embodiments, the first temperature sensor 218 may be in electrical communication with the controller 226. The controller 226 may be configured to modulate the temperature of the liquid exiting the first heater 216, for example by modulating a power level provided to the first heater 216. The controller 226 may be configured to base the temperature modulation on information received from the first temperature sensor 218. While the embodiment shown depicts only a first temperature sensor, it should be appreciated that a second temperature sensor may be similarly included between the second heater 222 and the second brew chamber 104. Embodiments with further chambers and heaters may include additional temperature sensors.

In some embodiments, an air valve 208 may be provided between the liquid supply 202 and the pump 210. The air valve 208 may allow air trapped within the liquid to escape the flow path prior to entering the pump 210. This may contribute to more efficient operation of the pump 210 and any downstream components, or reduce a likelihood of damage to the pump 210 or any downstream components.

In some embodiments, a pressure relief valve 212 may be provided between the pump 210 and the valve 214. The pressure relief valve 212 may allow liquid from the pump 210 to bypass the valve 214 in the event that excess pressure builds between the pump 210 and the valve 214. Liquid from the pressure relief valve 212 may be allowed to exit the flow arrangement 200 through the first brew chamber 102, the second brew chamber 104, or any other appropriate outlet of the machine. In this way, the pressure relief valve 212 may prevent a build-up of excess pressure between the pump 210 and the valve 214. This configuration may prevent damage to the pump 210, the valve 214, and/or other system components, particularly in the event that the valve 214 or another downstream component becomes blocked or clogged.

In some embodiments, a liquid level detector 206 may be provided in the flow arrangement 200 near the liquid supply 202. In some embodiments, the liquid level detector may be a conductivity probe positioned near an outlet of the liquid supply 202. The liquid level detector may sense when the liquid in the liquid supply 202 is below a threshold fill level, such as when the liquid supply is empty or nearly empty. The liquid level detector 206 may be in electrical communication with the controller 226 and/or a user interface.

The structures shown in the illustrative embodiment of FIG. 1 will now be described.

The liquid supply 202 may be configured to provide a liquid for forming a beverage. In some embodiments, the liquid supply 202 may be coupled to the housing 124. In some embodiments, the liquid supply 202 may be removably couplable to the housing 124. In other embodiments, the liquid supply may include an external water source such as a tap line, a refrigerator, or a faucet.

In some embodiments, a liquid level detector may be provided to monitor a fill level of the liquid supply 202. The liquid level detector may be any appropriate device for monitoring a liquid level, including a contact probe, an optical probe, a conductivity probe, or any other appropriate detector.

In some embodiments, the liquid supply 202 may include temperature controls to maintain a temperature of the liquid contained therein. For example, the liquid supply may be chilled to maintain a cool temperature of the liquid.

The first brew chamber 102 and the second brew chamber 104 may be configured to form beverages of any appropriate kind, in any appropriate volume, and at any appropriate temperature. In the embodiment shown, the first brew chamber 102 may be configured to form a smaller beverage volume than the second brew chamber 104.

For example, as shown in the illustrative embodiment of FIG. 3, the first brew chamber 102′ may be configured to brew a single-serve beverage volume, although this is not required. In some embodiments, the first brew chamber 102′ may include a cartridge holder 221 configured to receive a beverage cartridge 230 that contains a beverage material. The cartridge holder 221 may be configured to introduce liquid from the liquid supply into the beverage cartridge to form a first beverage. In some embodiments, the first brew chamber 102′ may include one or more inlet needles 223 for introducing liquid into the beverage cartridge 230. Alternatively or in addition, in some embodiments, the first brew chamber 102′ may include one or more outlet needles 225 for directing brewed beverage out of the beverage cartridge 230.

In some embodiments, the first brew chamber 102 may have a first brew chamber lid 108 (see FIG. 1) that may be movable relative to the housing 124. Moving the first brew chamber lid 108 may expose the first brew chamber 102 and allow a user to place a cartridge into the first brew chamber 102.

In some embodiments, the first brew chamber 102 is configured to introduce liquid to a beverage cartridge at a pressure of less than 1 bar. In other embodiments, however, the first brew chamber may be configured to introduce liquid to a beverage cartridge at a pressure of more than 1 bar.

In some embodiments, the first brew chamber lid 108 may include electromechanical components and functions, such that movement or operation of the first brew chamber lid 108 may be detected by a controller of the beverage machine 100.

The second brew chamber 104 may be a configured to form a larger beverage volume compared to the first brew chamber 102, although this is not required. For example, the second brew chamber may be configured to brew multiple servings of a beverage and may dispense the beverage into a carafe 114. The second brew chamber 104 may be configured to receive and hold a beverage material. In some embodiments, the beverage material may be held inside a filter (e.g. a re-useable mesh filter or a paper filter). The second brew chamber 104 may be configured to introduce a liquid from the liquid supply to the beverage material in the second brew chamber 104 to form a second beverage.

In some embodiments, as shown in the illustrative embodiment of FIG. 3, the second brew chamber 104′ may include a shower head 227 configured to distribute liquid across a beverage material, e.g. across a bed of coffee grounds.

The second brew chamber 104 may have a second brew chamber lid 112 (see FIG. 1) that may be movable relative to the housing 124. Moving the second brew chamber lid 112 may expose the second brew chamber 104 and allow a user to place a beverage material into the second brew chamber 104. In some embodiments, the second brew chamber 104 may comprise a drip coffee style brewer. In such embodiments, moving the second brew chamber lid 112 may expose the second brew chamber 104 and allow a user to place coffee grounds into the second brew chamber 104.

In some embodiments, the second brew chamber 104 is configured to introduce liquid to a beverage material at a pressure of less than 1 bar. In other embodiments, however, the second brew chamber may be configured to introduce liquid to a beverage material at a pressure of more than 1 bar.

The second brew chamber lid 112 may include electromechanical components and functions, such that movement or operation of the second brew chamber lid 112 may be detected by a controller of the beverage machine 100.

In some embodiments, the first and second brew chambers may be configured to form beverages of the same volume. In some embodiments, the first and second brew chambers may each be configured to form a range of beverage volumes, where the ranges may overlap with one another. As such, the disclosure is not limited with regard to the beverage volume formed in each chamber.

While some of the embodiments described herein include chambers configured to brew beverages such as coffee, a chamber may also be configured to form beverages other than coffee, as the disclosure is not limited in this regard. A beverage machine according to the present disclosure may include a chamber configured to form any suitable beverage, such as tea, coffee, other infusion-type beverages. Alternatively or additionally, a beverage machine may include a chamber configured to form a beverage from a liquid or powdered concentrate, soups, juices, sodas, or other beverages made from dried materials.

The beverage machine 100 may include a base 116. The base 116 may be positioned at least partially below at least one brew chamber. The base 116 may configured to receive one or more vessels for accepting and containing a beverage prepared by the beverage machine. For example, the base 116 may be configured to receive a carafe 114 for accepting and containing a coffee beverage prepared by the beverage machine 100. Alternatively or additionally, the base 116 may be configured to receive a cup 110 for accepting and containing a beverage prepared by the beverage machine. In the embodiment shown, the base 116 includes both a cup holder 120 and a carafe holder 118. The cup holder 120 may be positioned at least partially under the first brew chamber 102. The cup holder 120 may receive a cup 110 for accepting and containing a beverage dispensed from the first brew chamber 102. The carafe holder 118 may be positioned at least partially under the second brew chamber 104. The carafe holder 118 may receive a carafe 114 for accepting and containing a beverage dispensed from the second brew chamber 104.

In some embodiments, the base 116 may be configured to provide a warming effect to the one or more vessels. For example, the base may include a heater. In some embodiments, the base 116 may include a heater as part of the carafe holder 118, the cup holder 120, or both the carafe holder 118 and the cup holder 120. In some embodiments, the heater(s) used to heat the base may be the same heater(s) used to heat water from the liquid supply. In the embodiment shown in FIG. 1, the second heater 222 used to heat liquid directed to the second brew chamber 104 also serves to heat a warming plate 119 of the carafe holder 118.

The beverage machine 100 may also include a user interface 106. The user interface may be positioned and oriented so as to be viewed and operated by a user positioned at the front of the beverage machine. In the embodiment shown, the user interface 106 may be positioned on the first brew chamber lid 108. However, in other embodiments, the user interface 106 may be positioned at any appropriate location on the beverage machine 100. For example, in some embodiments the user interface 106 may be positioned on a front panel 106A of the second brew chamber 104. In other embodiments, the user interface may be positioned on a front panel 106B of the first brew chamber 102, on the second brew chamber lid 112, or at any other location on the beverage machine 100 as the disclosure is not limited in this regard.

A user interface 106 may include one or more of the following: a display, one or more buttons, and one or more indicator lights. The user may provide commands or input to the beverage machine through the user interface by, for example, pressing a button or touching a touch screen. The beverage machine may perform different functions in response to the commands from the user. For example, a beverage may be formed in a first brew chamber 102 in response to a user inputting a first type of command via the user interface. A beverage may be formed in a second brew chamber 104 in response to a user inputting a second type of command via the user interface. Formation of the beverage in either the first brew chamber 102 or the second brew chamber 104 may be enabled by actuation of a valve of the beverage machine 100, as discussed above.

Information may be communicated to the user through a display or indicator lights of the user interface. For example, the user interface 106 may alert a user when information from a liquid level detector of the beverage machine 100 indicates that a volume of liquid in the liquid supply has reached a threshold level (i.e., a maximum or a minimum).

It should be understood that a user interface may include any number or combination of the above-mentioned components, or any other appropriate components. In some embodiments, a user interface may include only a single touch screen that both receives commands from a user and communicates information to the user. In other embodiments, a user interface may include multiple buttons and multiple indicator lights. A user interface may include knobs, scroll wheels, mechanical switches, microphones, touch sensors, light sensors, or any other suitable components configured to receive input from a user. Additionally, a user interface may include displays, lights, speakers, haptic devices, or any other suitable components configured to provide information to a user.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage machine comprising:
a liquid supply configured to provide a liquid for forming a beverage;
a first brew chamber configured to hold a first beverage material and introduce liquid from the liquid supply to the first beverage material to form a first beverage of a first type of beverage, wherein the first brew chamber is configured to introduce liquid to the first beverage material at a pressure of less than 1 bar;
a second brew chamber configured to hold a second beverage material and introduce liquid from the liquid supply to the second beverage material to form a second beverage of a second type of beverage, the second type of beverage being different from the first type of beverage, wherein the second brew chamber is incapable of brewing the first type of beverage, and wherein the second brew chamber is configured to introduce liquid to the second beverage material at a pressure of less than 1 bar;
a pump configured to pump the liquid from the liquid supply to the first brew chamber and to the second brew chamber;
a valve downstream of the pump and configured to selectively control flow of liquid from the pump toward the first brew chamber and toward the second brew chamber;
a controller in communication with the valve and configured to actuate the valve to selectively control flow of liquid from the pump toward the first brew chamber and toward the second brew chamber;
a first heater configured to heat liquid directed to the first brew chamber; and
a second heater configured to heat liquid directed to the second brew chamber, the first and second heaters being different types of heaters,
wherein the first heater and the second heater are downstream of the valve.

2. The beverage machine of claim 1, wherein the first heater and the second heater comprise flow through heaters with different heater ratings.

3. The beverage machine of claim 2, wherein, compared to the first heater, the second heater has a heater rating that enables the second heater to heat a volume of water to an elevated temperature in less time than required by the first heater to heat the same volume of water to the same elevated temperature.

4. The beverage machine of claim 2, wherein a maximum flow rate of the second heater is different than a maximum flow rate of the first heater.

5. The beverage machine of claim 1, wherein the first heater comprises a spiral flow through heater.

6. The beverage machine of claim 1, wherein the second heater comprises a U-shaped flow through heater.

7. The beverage machine of claim 1, further comprising a user interface, wherein the controller is configured to actuate the valve in response to a user selection made by a user interacting with the user interface.

8. The beverage machine of claim 1, wherein the valve comprises a three-way valve.

9. The beverage machine of claim 1, further comprising a housing, wherein the liquid supply comprises a water reservoir that is removably couplable to the housing.

10. The beverage machine of claim 1, wherein the first beverage material is held within a beverage cartridge, and the first brew chamber is configured to introduce the liquid from the liquid supply into the beverage cartridge.

11. The beverage machine of claim 10, wherein the first brew chamber comprises a needle configured to pierce the beverage cartridge.

12. The beverage machine of claim 1, further comprising a carafe holder positioned under the second brew chamber.

13. The beverage machine of claim 12, wherein the carafe holder includes a warming plate, wherein the second heater heats the warming plate.

14. The beverage machine of claim 1, further comprising a warming plate, wherein the second heater heats the warming plate.

15. The beverage machine of claim 1, wherein a maximum beverage volume that can be formed by the second brew chamber is higher than a maximum beverage volume that can be formed by the first brew chamber.

16. The beverage machine of claim 1, wherein the pump serves as the sole fluid driving source that moves the liquid to the first brew chamber and to the second brew chamber.

17. The beverage machine of claim 1, wherein the first and second brew chambers cannot simultaneously form a beverage.

18. A beverage machine comprising:
a liquid supply configured to provide a liquid for forming a beverage;
a first brew chamber comprising a cartridge holder configured to receive a beverage cartridge, the first brew chamber being configured to introduce liquid from the liquid supply into the beverage cartridge to form a first beverage;
a second brew chamber configured to hold a beverage material and configured to introduce liquid from the liquid supply to the beverage material to form a second beverage, wherein the second brew chamber is configured to introduce liquid to the beverage material at a pressure of less than 1 bar;
a pump configured to pump the liquid from the liquid supply to the first brew chamber and to the second brew chamber;
a valve downstream of the pump and configured to selectively control flow of liquid from the pump toward the first brew chamber and toward the second brew chamber;
a controller in communication with the valve and configured to actuate the valve to selectively control flow of liquid from the pump toward the first brew chamber and toward the second brew chamber;
a first heater configured to heat liquid directed to the first brew chamber; and
a second heater configured to heat liquid directed to the second brew chamber,
wherein the first heater and the second heater are downstream of the valve.

19. The beverage machine of claim 18, wherein the first heater and the second heater comprise flow through heaters.

20-30. (canceled)

31. A method of forming a beverage, the method comprising:
providing a liquid supply, a pump, and a valve;
providing a first brew chamber configured to receive a beverage cartridge and configured to introduce liquid from the liquid supply into the beverage cartridge to form a first beverage;
providing a second brew chamber configured to hold a beverage material and configured to introduce liquid from the liquid supply to the beverage material to form a second beverage;
pumping, with the pump, liquid from the liquid supply through the valve;
directing the liquid through the valve toward either the first brew chamber or the second brew chamber; and
heating the liquid after the liquid has passed through the valve, wherein heating the liquid comprises using a first heater to heat liquid directed toward the first brew chamber, or using a second heater to heat liquid directed toward the second brew chamber.

32-40. (canceled)
